(19) United States
(12) Patent Application Publication
(10) Pub. No.: US 2026/0212713 A1
(43) Pub. Date: Jul. 23, 2026

(54) RISK ASSESSMENT BASED ON USAGE OF AUTONOMOUS DRIVING SYSTEMS

(71) Applicant: Quanata, LLC, San Francisco, CA (US)

(72) Inventors: Michael Spenser Weiss, San Marcos, CA (US); Gil Tamari, San Francisco, CA (US); Gregory Matthew Levitt, New York, NY (US); John William Kramer, Mechanicsburg, PA (US); Morgan Haire Bugbee, San Marino, CA (US)

(73) Assignee: Quanata, LLC, San Francisco, CA (US)

(21) Appl. No.: 19/028,843

(22) Filed: Jan. 17, 2025

(51) Int. Cl. G07C 5/08; G06Q 40/08; G07C 5/00

(52) U.S. Cl. CPC G07C 5/0816; G06Q 40/08; G07C 5/008; G07C 5/0808

(57) ABSTRACT

A computer-implemented method for risk assessment based on usage of autonomous driving systems. The method can include obtaining one or more data sets collected based on a driver operating one or more vehicles having one or more autonomous driving systems. The method also can include determining usage patterns for the one or more autonomous driving systems based at least on the one or more data sets. The method further can include generating, using a machine-learning model, a risk metric based at least on the usage patterns. The method additionally can include outputting the risk metric. Other embodiments are described.

### FIELD OF DISCLOSURE

The present disclosure generally relates to risk assessment based on usage of autonomous driving systems.

### BACKGROUND

The automotive industry has seen significant advancements in recent years,

particularly in the realm of autonomous and semi-autonomous driving technologies. These systems have been developed to enhance vehicle safety, improve driving efficiency, and provide a more comfortable driving experience. These systems can include adaptive cruise control, lane departure warnings, forward collision warnings, lane assist, and various levels of autonomous driving capabilities.

### BRIEF DESCRIPTIONS OF THE DRAWINGS

The figures described below depict various aspects of the systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

These are shown are shown in the drawings arrangements which are presently discussed, it being understood, however, that the present embodiments are not limited to the precise arrangements and are instrumentalities shown, wherein:

FIG. 1 illustrates a front elevation view of a computer system that is suitable for implementing an exemplary embodiment of the system disclosed in FIG. 3:

FIG. 2 illustrates a representative block diagram of an example of the elements included in the circuit boards inside a chassis of the computer system of FIG. 1;

FIG. 3 illustrates a block diagram of a system for risk assessment based on usage of autonomous driving systems, according to one embodiment; and

FIG. 4 illustrates a flowchart for a method for risk assessment based on usage of autonomous driving systems, according to an embodiment.

The figures depict preferred embodiments for purposes of illustration only. One skilled in the art will readily recognize from the following discussion that alternative embodiments of the systems and methods illustrated herein can be employed without departing from the principles of the technology herein.

### DETAILED DESCRIPTION OF EXAMPLES OF EMBODIMENTS

The present embodiments can generally relate to risk assessment based on usage of autonomous driving systems. As such technologies become more prevalent in modern vehicles, there is an increasing impact on driver behavior, vehicle safety, and overall risk profile of the driver. Traditional methods of evaluating driver risk and determining insurance premiums have primarily focused on factors such as driving history, age, and vehicle type. Some newer approaches also use telematics data, but without considering autonomous driving systems.

The integration of autonomous systems into vehicles has created a complex driving environment in which control can shift between the driver and the vehicle's autonomous driving systems. For example, drivers are typically able to engage, disengage, and/or override autonomous driving systems. This dynamic interaction between human and machine introduces new variables that may influence overall driving safety and risk. For instance, the frequency and manner in which a driver engages or disengages autonomous systems could potentially impact their risk profile. Furthermore, the effectiveness and reliability of autonomous systems can vary significantly between different vehicle manufacturers and models. This variability adds another layer of complexity to the task of accurately assessing driver risk in vehicles equipped with these technologies.

As the adoption of autonomous and semi-autonomous driving systems continues to grow, there is an increasing need for more sophisticated methods of risk assessment that can account for these new variables. Such methods can benefit various stakeholders, including insurance companies, fleet managers, and individual drivers, by providing more accurate and nuanced evaluations of driving risk in the context of modern automotive technologies.

In many embodiments, the systems and methods described herein can perform risk assessment based on the usage of autonomous driving systems in vehicles. This risk assessment approach combines can data from various sources, such as onboard vehicle systems and mobile devices, to analyze how a driver interacts with and utilize autonomous driving features and determine how that affects the driver's risk profile.

In some embodiments, the system can collect data sets from vehicles equipped with autonomous driving systems and from user devices while drivers operate these vehicles. The system can process this information to determine usage patterns of the autonomous features. These patterns can include the frequency and duration of autonomous system engagement, circumstances under which drivers activate or deactivate the systems, and how driving behavior differs between human-controlled and autonomous operation.

Using machine learning models, the system can generate a risk metric based on the identified usage patterns. This risk metric can provide a quantitative assessment of the driver's risk profile, taking into account the driver's interaction with the autonomous driving systems. The resulting metric can be used for various purposes, such as determining insurance premiums or evaluating overall driving safety in the context of the driver's use of autonomous driving systems.

Advantages will become more apparent to those skilled in the art from the following description of the preferred embodiments which have been shown and described by way of illustration. As will be realized, the present embodiments can be capable of other and different embodiments and their details are capable of modification in various respects. Accordingly, the drawings and descriptions are to be regarded as illustrative in nature and not as restrictive.

In several embodiments, the techniques described herein can provide a practical application and several technological improvements. For example, the risk assessment system can provide enhanced data utilization, by leverages complex telematics data and driving patterns to extract meaningful insights, maximizing the value of available data sources; improved risk quantification, by incorporating autonomous system usage patterns to provide a more accurate and nuanced assessment of risk compared to traditional methods that may not account for these advanced vehicle features; real-time processing capabilities, by analyzing data streams in real-time, allowing for dynamic risk assessment and enabling adaptive insurance models; machine learning integration, by using advanced machine learning models allows for continuous improvement in risk assessment accuracy as more data becomes available; automated detection of autonomous system engagement, by inferring when autonomous features are being used even without direct signals, through analysis of driving behavior patterns.

### EXEMPLARY COMPUTER SETTINGS

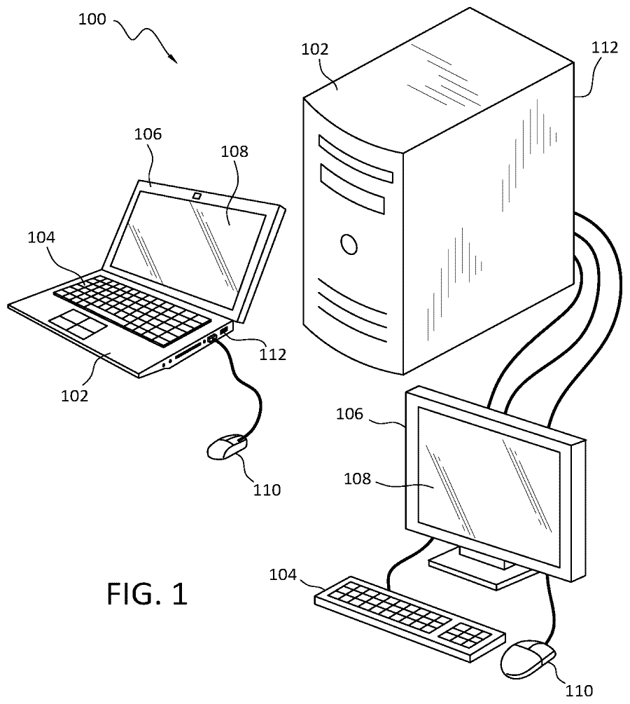

Turning to the drawings, FIG. 1 illustrates an exemplary embodiment of two different types (e.g., a laptop and a tower server) of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part, or all of, the techniques described herein. Computer system 100 can comprise chassis 102 containing one or more circuit boards (not shown) and one or more of an input/output port 112 (e.g., one or more universal serial bus (USB) ports of one or more types (e.g., USB type-A, type-B, type-C, micro-A, micro-B, mini-A, mini-B, etc.), one or more High-Definition Multimedia interface (HDMI) ports, etc.).

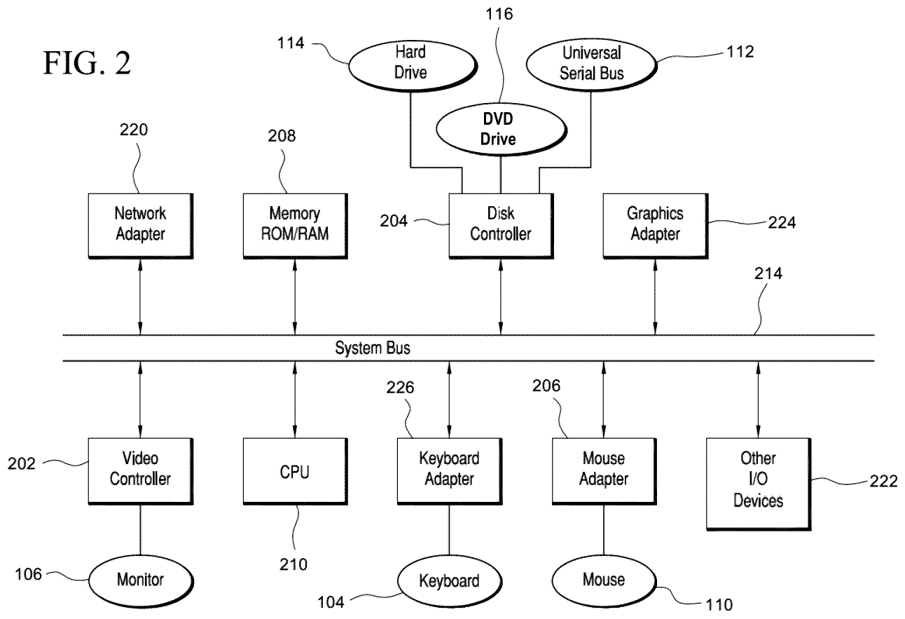

A representative block diagram of the elements included on the circuit boards inside chassis 102 is shown in FIG. 2. A central processing unit (CPU) 210 in FIG. 2 is coupled to a system bus 214. In various embodiments, the architecture of CPU 210 can be compliant with any of a variety of commercially distributed architecture families.

Continuing with FIG. 2, system bus 214 can also be coupled to a memory storage unit 208 that includes both read only memory (ROM) and random-access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to input/output port 112 (FIGS. 1-2)), hard drive 114 (FIG. 2), and/or one or more CD-ROM, DVD, Blu-Ray, or other suitable media, such as media configured to be used in a CD-ROM and/or DVD drive 116 (FIG. 2) inside chassis 102 (FIG. 1) or in a detachable drive coupled to input/output port 112.

Non-volatile or non-transitory memory storage unit(s) refer to the portions of the memory storage unit(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS.

Further exemplary operating systems can include: (i) the iOS® operating system by Apple Inc. of Cupertino, California, United States of America, or (ii) the Android™ operating system developed by Google, of Mountain View, California, United States of America.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 can be coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIG. 2), input/output port 112 (FIGS. 1-2), and CD-ROM and/or DVD drive 116 (FIG. 2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 by having wireless communication capabilities integrated into the motherboard chipset (not shown), and/or implemented via one or more dedicated wireless communication chips (not shown), connected through a PCI (peripheral component interconnector) or a PCI express bus of computer system 100 (FIG. 1) or input/output port 112 (FIG. 1). In other embodiments, network adapter 220 can comprise and/or be implemented as a wired network interface controller card (not shown).

Although many other components of computer system 100 are not shown, such components and their interconnection are well known to those of ordinary skill in the art. Accordingly, further details concerning the construction and composition of computer system 100 and the circuit boards inside chassis 102 are not discussed herein.

When computer system 100 in FIG. 1 is running, program instructions stored on a USB drive in input/output port 112, on a CD-ROM or DVD in CD-ROM and/or DVD drive 116 (FIG. 2) or in the detachable CD-ROM and/or DVD drive coupled to input/output port 112, on hard drive 114 (FIG. 2), or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general-purpose computer to a special purpose computer.

For purposes of illustration, programs and other executable program components are shown herein as discrete systems, although it is understood that such programs and components can reside at various times in different storage components of computer system 100 and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a laptop computer or a tower server in FIG. 1, there can be examples where computer system 100 can take a different form factor while still having functional elements similar to those described for computer system 100. In some embodiments, computer system 100 can comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 can comprise a portable computer, such as a laptop computer. In certain other embodiments, computer system 100 can comprise a mobile device, such as a smartphone, smart glasses, smart watch, smart rings, wearable, virtual reality headset, augmented reality glasses, etc. In certain additional embodiments, computer system 100 can comprise an embedded system.

### EXEMPLARY COMPUTER SYSTEMS FOR RISK ASSESSMENT BASED ON USAGE OF AUTONOMOUS DRIVING SYSTEMS

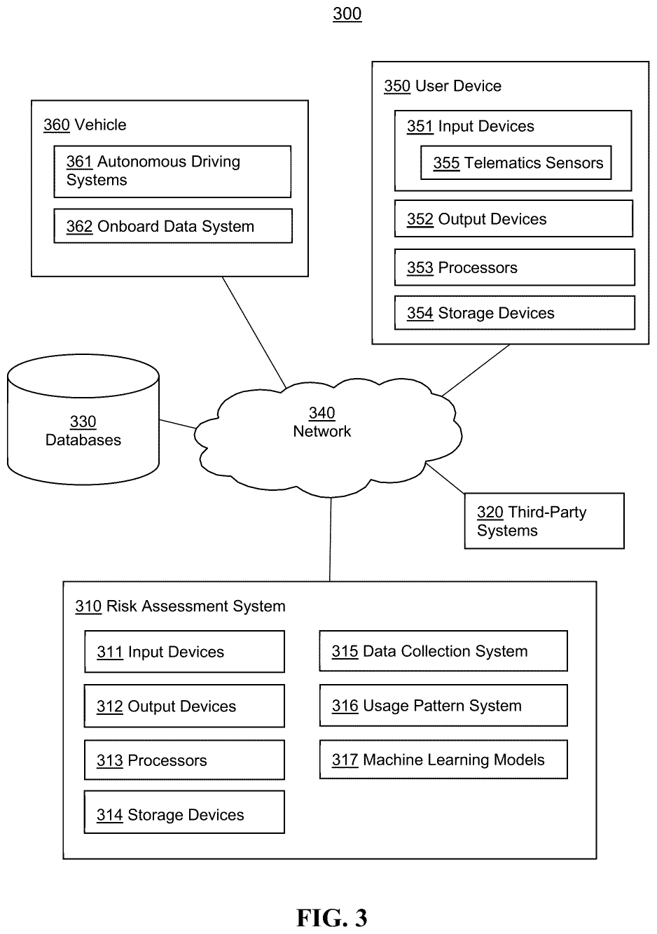

Turning ahead in the drawings, FIG. 3 illustrates a block diagram of a system 300 for risk assessment based on usage of autonomous driving systems, according to one embodiment. System 300 is exemplary, and embodiments of the system are not limited to the embodiments presented herein. The system can be employed in many different embodiments or examples not specifically depicted or described herein. In some embodiments, certain elements, modules, or systems of system 300 can perform various procedures, processes, operations, actions, and/or activities. In other embodiments, the procedures, processes, operations, actions, and/or activities can be performed by other suitable elements, modules, or systems of system 300. Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In some embodiments, system 300 can include a risk assessment risk assessment system 310, one or more third-party system 320, one or more databases 330, a network 340, one or more user devices 350, one or more vehicles, and/or other suitable components. Risk assessment system 310, third-party systems 320, and user device 350 can each be a computer system, such as computer system 100 (FIG. 1), as described above, and can each be a single computer, a single server, or a cluster or collection of computers or servers, or a cloud of computers or servers. In another embodiment, a single computer system can host each of risk assessment system 310 and user device 350. Risk assessment system 310 can be configured to collect and analyze data related to autonomous driving feature usage. Vehicle 360 can be equipped with autonomous driving systems and may generate data related to the operation and usage of these systems. User device 350 can be a mobile device carried by a driver of the vehicle 360 and may collect additional telematics data.

In some embodiments, risk assessment system 310 can be in data communication, through a network 340 (e.g., the Internet), with third-party systems 320, databases 330, user device 350, and/or vehicle 360. In some embodiments, user device 350 can be used by drivers (e.g., a licensed driver, an unlicensed driver, an insurance policyholder, an applicant for an auto insurance policy or a professional driver's job, etc.).

In various embodiments, risk assessment system 310 can include one or more input devices 351, one or more output devices 352, one or more processors 353, one or more storage devices 354, a data collection system 315, a usage pattern system 316, machine learning models 317, and/or other suitable components. Examples of input devices 311 can include one or more keyboards (e.g., keyboard 104 (FIG. 1)), one or more keypads, one or more pointing devices such as a computer mouse or computer mice (e.g., mouse 110 (FIG. 1)), one or more interactive touchscreen displays, a microphone, a camera, etc. Examples of output devices 312 can include one or more display or output device, such as one or more monitors (e.g., monitor 106 (FIG. 1)), one or more interactive touch screen displays (e.g., screen 108 (FIG. 1)), projectors, etc. Examples of processors 313 can include CPU 210 (FIG. 2), etc. Examples of storage devices 314 can include memory storage unit 208 (FIG. 2), external storage units coupled to input/output port 112 (FIGS. 1-2), hard drive 114 (FIG. 2), CD-ROM and/or DVD drive 116 (FIG. 2), a detachable drive coupled to input/output port 112 (FIGS. 1-2), etc. Input devices 311 and/or output devices 312 can be coupled to risk assessment system 310 in a wired manner and/or a wireless manner, and the coupling can be direct and/or indirect, as well as locally and/or remotely. As an example of an indirect manner (which can or cannot also be a remote manner), a keyboard-video-mouse (KVM) switch can be used to couple input devices 311 and output devices 312 to processors 313 and/or storage devices 314. In some embodiments, the KVM switch also can be part of risk assessment system 310. In a similar manner, the processors and/or the non-transitory computer-readable media can be local and/or remote to each other.

In some embodiments, data collection system 315, usage pattern system 316, and/or machine learning models 317 can be implemented in computing instructions (e.g., software modules) stored on non-transitory computer-readable media (e.g., storage devices 314) and executed by processors 313. In other embodiments, these components of risk assessment system 310 can be implemented in hardware.

In some embodiments, data collection system 315 can gather and/or organize data from various sources, such as connected car data, telematics data, and other relevant information related to autonomous driving system usage. Data collection system 315 can interface with various data providers, including connected car systems, mobile devices, and third-party databases (such as car manufacturer's computer systems). Data collection system 315 can perform data validation and cleaning processes to provide for quality and consistency of incoming information. Data collection system 315 can be capable of handling large volumes of real-time data streams, as well as batch processing of historical data. Data collection system 315 can implement data compression and efficient storage techniques to manage the potentially vast amounts of collected information.

In some embodiments, usage pattern system 316 can analyze the collected data to determine patterns in the usage of autonomous driving systems. These patterns can include frequency of use; duration of use; timing of use; circumstances surrounding and involved with use; circumstances under which the autonomous features are engaged or disengaged; patterns and/or circumstances involved with assistance, warning signals, and/or indications provided by the autonomous driving systems (e.g., assistance staying in a lane, warning of lane departure, etc.), and patterns and/or circumstances involved with disengagement signals provided to the driver (e.g., indicating that the autonomous is automatically disengaging (or will disengage within a short time (e.g., a few seconds)) based on a condition (e.g., a hands-off warning message that the autonomous driving system will disengage if the driver does not re-engage with steering); patterns and/or circumstances involved with the driver overriding autonomous assistance (e.g., the driver steering against steering intervention provided by the autonomous system); patterns and/or circumstances regarding adjustable settings of autonomous driving systems (e.g., adjustable following-distance setting for adaptive cruise control); and/or other suitable circumstances and/or patterns.

Determining use or usage of autonomous driving systems can involve determining use autonomous driving systems and/or non-use of available autonomous driving systems. Usage pattern system 316 can analyze the collected data to determine patterns in the usage of autonomous driving systems. Usage pattern system 316 can use statistical model and/or machine-learning models to detect trends and anomalies in autonomous system usage across different drivers and vehicle types. Usage pattern system 316 can segment usage patterns based on circumstances such as time of day, road type, weather conditions, and traffic density. Usage pattern system 316 can analyze the sequence and timing of autonomous feature activations and deactivations to understand driver preferences and behaviors, and the circumstances surrounding such behaviors. Usage pattern system 316 can generate data that can be used in machine learning models 317 in generating accurate risk metrics.

In some embodiments, usage pattern system 316 also can be used to analyze patterns in the collected data, such as telematics data collected on user device 350 to identify when a driver is using one or more autonomous driving systems, even when direct signals of such use is not available, and/or can include identifying switches between manual control and autonomous mode on one or more autonomous driving systems, even when direct signals of these transitions are not available. This capability can be particularly useful when working with limited or indirect data sources, such as telematics data collected from user device 350.

Usage pattern system 316 can utilize various techniques to accomplish this task. For example, the techniques can involve performing behavioral pattern recognition, by analyzing driving behavior patterns to identify characteristics typical of autonomous system operation versus manual driving, such as detecting more consistent speeds, smoother acceleration and deceleration, or more precise lane positioning during autonomous mode. The techniques can involve applying statistical techniques to the collected data to identify significant changes in driving patterns that indicate transitions between manual and autonomous modes. The techniques can involve performing machine learning algorithms, such as supervised or unsupervised learning algorithms to classify driving segments as manual or autonomous based on various features extracted from the telematics data. The techniques can involve performing time series analysis, in which usage pattern system can detect recurring patterns or abrupt changes in temporal data, which signify engagement or disengagement of autonomous features. The techniques can involve performing contextual inferencing, in which usage pattern system 316 considers contextual information, such as road type, traffic conditions, or time of day, to infer the likelihood of autonomous system usage in specific scenarios. The techniques can involve performing sensor fusion, when multiple data sources are available, to combine and correlate information from different sensors to improve the accuracy of its inferences. The techniques can involve performing anomaly detection, which can identify unusual patterns or deviations from expected behavior that could indicate transitions between driving modes. The techniques can involve performing frequency domain analysis, in which time-domain data can be transformed into the frequency domain, in order to detect subtle changes in driving characteristics that are indicative of autonomous system engagement or disengagement. The techniques can involve performing probabilistic modeling, which can use probabilistic approaches to estimate the likelihood of autonomous system usage based on observed data patterns. The techniques can involve performing heuristic rules, based on expert knowledge and empirical observations, usage pattern system 316 can apply a set of rules to infer autonomous system usage under certain conditions. By employing one or more of these techniques, usage pattern system 316 can determine autonomous driving system usage patterns, even when direct signals indicating autonomous driving system usage, engagement, and disengagement are unavailable, enhancing the overall risk assessment capabilities of the system.

In some embodiments, machine learning models 317 can process the collected data and/or usage patterns to generate risk metrics. In some cases, machine learning models 317 can include one or more models, such as one or more of the following: decision tree models, which can capture complex relationships between autonomous system usage patterns and risk factors; random forest models, combining multiple decision trees to improve prediction accuracy and reduce overfitting; gradient boosting models, such as XGBoost or LightGBM, for handling high-dimensional data and capturing non-linear relationships; logistic regression models for binary classification tasks, such as predicting the likelihood of a specific risk event; support vector machines (SVM) for classification and regression tasks, particularly effective in high-dimensional spaces; neural networks, including deep learning models, for capturing complex patterns in large datasets; time series models, such as ARIMA (autoregressive integrated moving average) or LSTM (long short-term memory) networks, for analyzing temporal patterns in autonomous system usage; ensemble models that combine predictions from multiple model types to improve overall accuracy and robustness; clustering algorithms, like K-means or DBSCAN, for identifying groups of similar driving behaviors or usage patterns; anomaly detection models to identify unusual or potentially risky autonomous system usage patterns; logistic regression models; and/or other suitable machine-learning models.

Machine learning models 317 can be trained on historical data to identify correlations between autonomous driving system usage and risk factors. Machine learning models 317 can be trained using historical data collected from vehicles equipped with autonomous driving systems. The training process can involve inputting training data sets, which can include training inputs, such as autonomous system usage patterns, vehicle telemetry, driver behavior, etc., and training outputs, such as risk outcomes. In some embodiments, relevant features can be extracted or created from the raw data to capture aspects of autonomous system usage and risk factors. In many embodiments, the models can be trained on a portion of the dataset, using techniques such as cross-validation to prevent overfitting, and in some cases, hyperparameter tuning can be performed to optimize model parameters using methods like grid search or Bayesian optimization to improve performance. In many embodiments, validation of the model can be performed by testing the models on a separate validation dataset to assess their generalization capabilities and predictive accuracy. Ensemble methods can be used in some cases by combining multiple models to create ensemble predictions. The models can be updated periodically with new data to adapt to changing patterns in autonomous system usage and risk factors.

In some embodiments, user device 350 can include one or more input devices 351, one or more output devices 352, one or more processors 353, and/or one or more storage devices 354. Examples of input devices 351 can include one or more keyboards, one or more keypads, one or more pointing devices such as a computer mouse or computer mice, one or more interactive touchscreen displays, a microphone, a camera, keyboard 104 (FIG. 1), mouse 110 (FIG. 1), telematics sensors 355, etc. In many embodiments, telematics sensors 355 can include sensors of a smartphone, such as a Global Positioning System (GPS), a camera, an accelerometer, an internal measurement unit, a gyroscope, a magnetometer, a proximity sensor, an ambient light sensor, a microphone. etc., which can be used to collect telematics data while the driver is driving with user device 350 in vehicle 360. Examples of output devices 352 can include one or more monitors, one or more touch screen displays, projectors, monitor 106 (FIG. 1), screen 108 (FIG. 1), etc. Examples of processors 353 can include CPU 210 (FIG. 2), etc. Examples of storage devices 354 can include memory storage unit 208 (FIG. 2), external storage units coupled to input/output port 112 (FIGS. 1-2), hard drive 114 (FIG. 2), CD-ROM and/or DVD drive 116 (FIG. 2), a detachable drive coupled to input/output port 112 (FIGS. 1-2), etc. Input devices 351 and output devices 352 can be coupled to user device 350 in a wired manner and/or a wireless manner, and the coupling can be direct and/or indirect, as well as locally and/or remotely. In a similar manner, processors 353 and/or storage devices 354 can be local and/or remote to each other.

In various embodiments, user device 350 can be a mobile device, and/or other endpoint devices used by one or more users. A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device (e.g., smart glasses, smart watches, smart rings, an augmented-reality (AR) headset, a virtual-reality (VR) headset, etc.), or another portable computer device with the capability to present audio and/or visual data (e.g., images, videos, music, etc.). Thus, in several examples, a mobile device can include a volume and/or weight sufficiently small as to permit the mobile device to be easily conveyable by hand. For examples, in some embodiments, a mobile device can occupy a volume of less than or equal to approximately 1790 cubic centimeters (cc), 2434 cc, 2876 cc, 4056 cc, and/or 5752 cc. Further, in these embodiments, a mobile device can weigh less than or equal to 15.6 Newtons, 17.8 Newtons, 22.3 Newtons, 31.2 Newtons, and/or 44.5 Newtons. Exemplary mobile devices can include (i) an iPod®, iPhone®, iTouch®, iPad®, MacBook® or similar product by Apple Inc. of Cupertino, California, United States of America, and/or (ii) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, and/or (ii) the Android™ operating system developed by the Open Handset Alliance.

Meanwhile, in several embodiments, risk assessment system 310 also can be configured to communicate with databases 330. Databases 330 can store various types of data related to the operation of the risk assessment system, such as historical driving data for individual drivers and vehicles; autonomous driving system usage logs and patterns; vehicle telemetry data, including speed, acceleration, braking, and location information; driver behavior metrics and patterns; environmental and road condition data; traffic incident reports and statistics; vehicle make, model, and feature specifications; autonomous system capabilities and limitations for different vehicle models; risk assessment models and parameters; machine learning model training data and results; user profiles and demographic information; insurance claim history and statistics; regulatory and compliance information related to autonomous vehicles; mapping and geolocation data; weather and climate data; time and date information for all recorded events; system performance metrics and error logs; data quality and validation metrics; anonymized aggregated statistics on autonomous feature usage across the user base; historical risk metrics and their associated factors; and/or other suitable information This dataset enables the risk assessment system to perform detailed analyses and generate accurate risk metrics based on autonomous driving system usage and other relevant information. Databases 330 also can store data collected by data collection system 315, usage patterns generated by usage pattern system 316, and/or information used by machine learning models 317, such as trained parameters, etc.

The databases 330 can be stored on storage devices 314 of risk assessment system 310 or external to risk assessment system 310. Also, in some embodiments, for any particular database of databases 330, that particular database can be stored on a single storage device or the contents of that particular database can be spread across multiple ones of the storage devices storing databases 330, depending on the size of the particular database and/or the storage capacity of the storage devices.

Databases 330 can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, system 300, risk assessment system 310, and/or databases 330 can be implemented using any suitable manner of wired and/or wireless communication. Accordingly, system 300 and/or risk assessment system 310 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc.

The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

Vehicle 360 can include a motorized conveyance configured for transporting passengers and/or cargo on roads or other surfaces. In some aspects, vehicle 360 can be an automobile, truck, van, bus, or other wheeled vehicle. Vehicle 360 can include various systems and components to enable operation, such as an engine or motor for propulsion, which can be an internal combustion engine, electric motor, hybrid system, or other power source; a transmission system for transferring power from the engine/motor to the wheels; a steering system for directional control; a braking system for slowing and stopping the vehicle; a suspension system for absorbing shocks and vibrations; and/or other suitable components.

Additionally, vehicle 360 can be equipped with one or more autonomous driving systems 361. These autonomous systems can include sensors, controllers, and actuators that enable vehicle 360 to perform certain driving tasks without human input or with reduced human input. The autonomous capabilities can range from basic driver assistance features to fully autonomous operation in some driving scenarios. For example, autonomous driving systems can include autonomous or semi-autonomous driving technologies, which can include adaptive cruise control, lane keeping assist, automatic emergency braking, blind spot detection, traffic sign recognition, parking assist, highway driving assist, autonomous valet parking, traffic jam assist, automated lane changing, driver attention monitoring, pedestrian detection, cross-traffic alert, night vision assist, autonomous emergency steering, predictive cruise control, intersection collision avoidance, automated overtaking, platooning systems, self-parking systems, self-driving systems at various levels of capability for autonomous driving (e.g., level 1 driver assistance, level 2 partial driving automation, level 3 conditional driving automation, level 4 high driving automation, level 5 full driving automation), and/or other autonomous or semi-autonomous systems.

In many embodiments, vehicle 360 can include an onboard data system 362 for collecting, processing, and/or transmitting data related to vehicle operations and usage of autonomous driving systems 361. Onboard data system 362 can include one or more processors, memory, storage devices, and/or communication capabilities (e.g., wireless and/or wired communication systems). Onboard data systems 362 can interface with various vehicle sensors and systems to gather operational data of vehicle 360. For example, the operational data can include vehicle speed, acceleration, braking, steering inputs, GPS location, autonomous system engagement status, and sensor readings from cameras, lidar, radar, and other perception systems. In some cases, onboard data system 362 can perform preliminary data processing and analysis onboard vehicle 360. Such processing can include filtering raw sensor data, detecting anomalies or significant events, and compressing data for efficient storage or transmission.

In some cases, onboard data system 362 can interface with the vehicle's OBD-II (On-Board Diagnostics II) port to transmit connected car data. The OBD-II port, typically located under the dashboard, provides access to various vehicle subsystems and diagnostic information. In some aspects, a hardware device can be plugged into the OBD-II port to establish a connection with onboard data system 362. This device can include a processor, memory, and wireless communication capabilities. The device can continuously or periodically query the vehicle's systems through the OBD-II port to obtain relevant data.

Data collected through the OBD-II port can include engine RPM and load, vehicle speed, throttle position, fuel system status, coolant temperature, intake air temperature, mass air flow, oxygen sensor readings, diagnostic trouble codes (DTCs), and/or other suitable information. In some cases, the OBD-II interface also can provide access to additional vehicle-specific data, depending on the manufacturer's implementation. This information can include information about the status and operation of autonomous driving systems 361 and/or other connected car data, such as data collected by onboard data system 362, etc.

The collected data can be processed and stored locally on the OBD-II device before being transmitted to external systems. Transmission can occur in real-time using cellular networks, or data may be buffered and sent in batches when a suitable connection is available. For data security and privacy, the OBD-II device and/or onboard data system 362 can implement encryption and authentication protocols for data storage and transmission. Access to sensitive vehicle data can be restricted based on user permissions and regulatory requirements.

Onboard data system 362 can be configured to transmit collected data to external systems, such as third-party systems 320 (e.g., car manufacturer's computer systems), user device 350, and/or risk assessment system 310, through various communication channels. The data transmission can occur in real-time, at predetermined intervals, or in response to specific trigger events. In some embodiments, data collection system 315 of risk assessment system 310 can collect data sets from third-party system 320, e.g., car manufacturer's computer systems.

### EXEMPLARY EMBODIMENTS FOR RISK ASSESSMENT BASED ON USAGE OF AUTONOMOUS DRIVING SYSTEMS

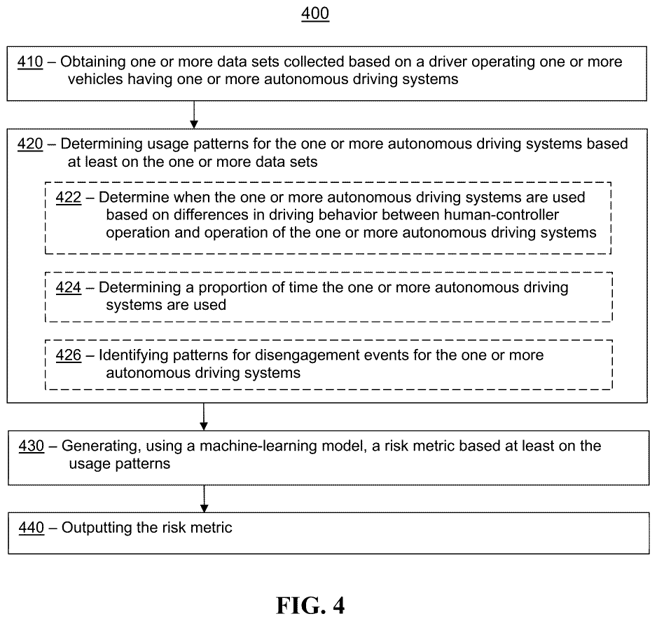

Turning ahead in the drawings, FIG. 4 illustrates a flowchart for a method 400 for risk assessment based on usage of autonomous driving systems, according to an embodiment. Method 400 can be implemented via execution of computing instructions configured to run on one or more processors and stored on one or more non-transitory computer-readable media. Method 400 is exemplary and is not limited to the embodiments presented herein. Method 400 can be employed in many different embodiments or examples not specifically depicted or described herein. In various embodiments, the procedures, the processes, the operations, the actions, and/or the activities of method 400 can be performed in the order presented. In other embodiments, the procedures, the processes, the operations, the actions, and/or the activities of method 400 can be performed in any suitable order. In still other embodiments, one or more of the procedures, the processes, the operations, the actions, and/or the activities of method 400 can be combined or skipped.

In several embodiments, system 300 or risk assessment system 310 (FIG. 3) (including one or more of its components, such as data collection system 315, usage pattern system 316, and/or machine learning models 317 (FIG. 3)) can be suitable to perform method 400 and/or one or more of the operations, actions, and/or activities of method 400. In these or other embodiments, one or more of the operations, actions, and/or activities of method 400 can be implemented as one or more computing instructions configured to run on one or more processors and configured to be stored on one or more non-transitory computer readable media. Such non-transitory computer readable media can be part of a computer system such as system 300 or risk assessment system 310. The processors can be similar or identical to the processors described above with respect to computer system 100 (FIG. 1).

Referring to the drawings, method 400 can include an activity 410 of obtaining one or more data sets collected based on a driver operating one or more vehicles having one or more autonomous driving systems. The data sets can be collected from various sources, such as onboard data system 362 of vehicle 360 (FIG. 3), telematics sensors 355 of user device 350 (FIG. 3), third-party systems 320 (e.g., car manufacturer's computer systems that have collected vehicle data from vehicle 360 (FIG. 3)), etc. The data can include on-board connected car data, telematics data, and/or other relevant information related to autonomous driving system usage. In many embodiments, activity 410 can be performed at least in part by data collection system 315 (FIG. 3).

In various embodiments, method 400 also can include an activity 420 of determining usage patterns for the one or more autonomous driving systems based at least on the one or more data sets. In many embodiments, activity 420 can involve analyzing the collected data to identify patterns in the usage of autonomous driving systems. In some cases, the usage patterns may be determined for specific autonomous driving features. For example, the activity 420 can analyze data related to the use of adaptive cruise control, forward collision avoidance, and lane departure assistance systems. In some cases, the activity 420 can account for different settings of autonomous driving features when determining usage patterns. For instance, activity 420 can consider the following-distance setting for adaptive cruise control when analyzing its usage. In many embodiments, activity 410 can be performed at least in part by usage pattern system 316 (FIG. 3).

In some embodiments, activity 420 can include an activity 422 of determining when the one or more autonomous driving systems are used. This analysis can be based on differences in driving behavior between human-controlled operation and operation of the one or more autonomous driving systems, as described above. For example, the telematics data can reveal distinct patterns in acceleration, braking, or steering that are characteristic of autonomous system operation versus human operation. The analysis can involve examining various parameters collected from vehicle sensors, such as vehicle speed, lateral acceleration, longitudinal acceleration, steering angle, and brake pedal pressure. Machine learning algorithms can be used to identify patterns in these parameters that are indicative of autonomous system engagement. For instance, autonomous systems can exhibit more consistent speeds and smoother acceleration profiles compared to human drivers. In some cases, the analysis also can consider contextual information, such as road type, traffic conditions, or time of day, to improve the accuracy of autonomous system usage detection. Activity 422 can use statistical methods to identify significant changes in driving patterns that could indicate transitions between manual and autonomous modes. Additionally, frequency domain analysis can be applied to detect subtle changes in driving characteristics that are indicative of autonomous system engagement or disengagement. By employing these techniques, activity 422 can be able to infer autonomous driving system usage even when direct signals of such use are not available. This capability can be particularly beneficial when working with limited or indirect data sources, allowing for a more comprehensive understanding of how drivers interact with autonomous features in real-world conditions.

In some embodiments, activity 420 also can include an activity 424 of determining a proportion of time the one or more autonomous driving systems are used. This proportion can be calculated by comparing the total time of vehicle operation to the time during which autonomous features were engaged. The proportion can be expressed as a percentage or ratio. Activity 424 can calculate this proportion for individual autonomous features separately, such as adaptive cruise control, lane keeping assist, and automated parking. This granular approach can offer a more nuanced understanding of which specific autonomous features are most utilized by drivers. The proportion may be determined over various time periods, such as per trip, daily, weekly, or monthly, allowing for trend analysis of autonomous system usage over time. In some cases, activity 424 can consider the circumstances or context in which autonomous features are used, such as highway driving versus city driving, or during different weather conditions. This contextual information can provide additional features regarding usage of autonomous driving systems. The proportion of autonomous system usage can also be compared across different drivers or vehicle models.

In some embodiments, activity 420 additionally can include an activity 426 of identifying patterns for disengagement events for the one or more autonomous driving systems. Disengagement events can occur when an autonomous system is deactivated, either by the driver or by the autonomous driving system itself. Activity 426 can analyze the frequency, timing, and circumstances of these disengagement events to identify meaningful patterns. For example, activity 426 can examine whether the disengagements occur in specific traffic conditions, road types, or weather situations. The analysis also can consider the duration of autonomous system engagement before a disengagement occurs, which can indicate the driver's level of comfort with the autonomous driving system. Patterns in driver-initiated disengagements can show situations in which drivers consistently choose to take manual control, which can be related to limitations in the autonomous system's capabilities or areas in which drivers lack trust. System-initiated disengagements, on the other hand, can indicate scenarios in which the autonomous system reaches its operational limits or there is driver non-compliance. Activity 426 can categorize disengagement events based on their causes, such as approaching complex intersections, encountering unexpected obstacles, or entering areas with poor lane markings. This categorization can provide relevant feature data regarding specific challenges faced by autonomous systems in real-world driving conditions. Temporal patterns in disengagements also can be analyzed, such as whether they occur more frequently at certain times of day or days of the week, which can reveal correlations between disengagements and factors like traffic density or driver fatigue. By identifying these patterns, activity 426 can provide feature data to beneficially improve performance of machine learning models (e.g., 317 (FIG. 3)).

In some embodiments, method 400 additionally can include an activity 430 of generating, using a machine-learning model, a risk metric based at least on the usage patterns. Activity 430 can include using one or more machine-learning models to process the collected data and usage patterns to produce a quantifiable measure of risk associated with how the driver uses autonomous driving systems or does not use available autonomous driving systems. Inputs to the machine learning model can include usage patterns of autonomous driving systems, including frequency and duration of use; patterns of disengagement events; contextual data such as road types, weather conditions, and traffic situations; driver behavior data when autonomous systems are not engaged; vehicle-specific data like make, model, and autonomous feature capabilities; and/or other suitable inputs. Outputs of the machine learning model can include a risk metric quantifying the overall risk associated with the observed autonomous system usage patterns; component risk scores for specific aspects of autonomous system usage; confidence intervals or uncertainty estimates associated with the risk metric; and/or other suitable outputs. In many embodiments, the risk metric can be specific to the driver's usage of the one or more autonomous driving systems, which can be output and used in various ways, including as a factor in determining a more comprehensive risk profile for the driver. In other embodiments, the autonomous driving systems usage information can be a factor among many others that are to determine a risk level for the driver, such that the comprehensive risk profile for the driver is output.

The machine learning model can be trained on historical data that includes autonomous system usage patterns and corresponding risk outcomes. Risk outcomes can include accidents (e.g., vehicle collisions), severity of accidents (e.g., magnitude of damage or injury), traffic violations, insurance claims, and/or other suitable factors. This training data can encompass a wide range of scenarios and driving conditions for robustness and generalizability. In generating the risk metric, the machine learning models can consider various factors derived from the usage patterns, such as frequency of autonomous system engagement, duration of use, patterns of disengagement, and the contexts in which these systems are used. The model can assign different weights to these factors based on their perceived importance in predicting risk. The risk metric generated by the model can be a numeric score, a composite score that takes into account multiple aspects of autonomous system usage, and/or another suitable metric. In many embodiments, the risk metric can consider not only how often the autonomous driving systems are used, but also how appropriately they are used given the driving conditions, and how such usage affects risk outcomes. The machine learning model can employ ensemble methods, combining predictions from multiple models to improve accuracy and robustness. This approach can use different types of models, such as decision trees, random forests, and neural networks, each capturing different aspects of the relationship between usage patterns and risk. As new data becomes available, the model can be continuously updated and refined, allowing it to adapt to changing patterns in autonomous system usage and evolving technology.

In some embodiments, method 400 additionally can include an activity 440 of outputting the risk metric. Activity 440 can involve presenting the generated risk metric in a format that is accessible and meaningful for use by the recipients and/or systems that use the output. The risk metric can be output through various channels, such as an API (Application Programming Interface), allowing integration with other systems or applications (e.g., third-party systems 320 (FIG. 3). This approach can enable real-time risk assessment for insurance companies, fleet managers, or other stakeholders. In some embodiments, the output can include breakdowns of the risk metric into component parts, showing how different aspects of autonomous system usage contribute to the overall risk assessment. This granular view can provide insights for targeted risk management strategies, such as for fleet managers to determine risk and provide further training on autonomous driving systems to drivers. In some embodiments, the risk metric can be used by as a factor in calculating insurance premiums, in which a lower risk metric can result in lower premiums.

### EXEMPLARY MACHINE LEARNING MODELS

In several embodiments, the systems and/or methods can use one or more ML (machine learning)/AI (artificial intelligence) models (e.g., machine learning model 317 (FIG. 3)) to perform one or more of the above-mentioned procedures, processes, activities, actions, operations, and/or methods. In addition to those machine-learning models described above, the machine learning models can include BERT, LLM, Lambda, Palm, XLNet, GPT-3, GPT-4, KNN, decision trees, linear regression, logistic regression, K-Means, neural networks, fuzzy logic, GANs, CTGAN, CNNs, VAEs, and so forth. In various embodiments, each of the ML/AI models used can be trained dynamically and/or regularly.

In various embodiments, the systems and/or methods can be configured to train or re-train the one or more ML/AI models. The training of each of the ML/AI models can be supervised, semi-supervised, and/or unsupervised—which in some embodiments can be followed by, or used in conjunction with, other techniques, such as re-enforcement machine learning techniques, or other techniques utilized by ChatGPT-based voice bots or virtual assistants. The training data of training datasets for pre-training or re-training each of the ML/AI models can be collected from various data sources, including historical input and/or output data by the ML/AI model. The collection and update of the training data in the training datasets can be performed once, periodically (e.g., every day, every week, etc.), or constantly. For example, in certain embodiments, the input and/or output data of an ML/AI model can be curated by a user (e.g., an ML engineer, a data scientist, etc.) or automatically collected every time the ML/AI model generates new output data to update the training datasets for re-training the ML/AI model. In many embodiments, the trained and/or re-trained ML/AI model as well as the training datasets can be stored in, updated, and accessed from a database (e.g., databases 330 (FIG. 3)). In the same or different embodiments, when more than one training dataset is used for the pre-training and/or re-training, the data of the more than one training dataset can be formatted or reformatted so that the hierarchy, schema, and/or other aspects of the data of the more than one training dataset (especially when datasets are from different sources) follow a common hierarchy, structure, schema, etc., and so that the data of the more than one training dataset can be more easily used to pre-train or re-train the one or more machine learning models. In many embodiments, the common hierarchy, structure, schema, etc. can be predetermined.

In some embodiments, the users, systems, and/or methods further can determine whether to add the newly created historical input and/or output data to the training dataset for retraining the ML/AI models based upon user feedback, predetermined criteria, and/or confidence scores for the historical output data. The user feedback can be associated with the output data of the ML/AI models or the output of the systems and/or methods using the ML/AI models.

In various embodiments, where machine learning techniques are not explicitly described in the processes, procedures, activities, operations, actions, and/or methods, such processes, procedures, activities, operations, actions, and/or methods can be read to include machine learning techniques suitable to perform the intended activities (e.g., determining, processing, analyzing, predicting, etc.). In several embodiments, the one or more ML/AI models can be configured to start or stop automatically upon occurrence of predefined events and/or conditions. In certain embodiments, the systems and/or methods can use a pre-trained ML/AI model, without any re-training.

### ADDITIONAL EXEMPLARY EMBODIMENTS

Various embodiments can include a computer-implemented method. The method can include obtaining one or more data sets collected based on a driver operating one or more vehicles having one or more autonomous driving systems. The method also can include determining usage patterns for the one or more autonomous driving systems based at least on the one or more data sets. The method further can include generating, using a machine-learning model, a risk metric based at least on the usage patterns. The method additionally can include outputting the risk metric.

A number of embodiments can include a system. The system can include one or more processors and one or more non-transitory computer-readable media storing computing instructions that, when executed on the one or more processors, cause the one or more processors to perform certain operations. The operations can include obtaining one or more data sets collected based on a driver operating one or more vehicles having one or more autonomous driving systems. The operations also can include determining usage patterns for the one or more autonomous driving systems based at least on the one or more data sets. The operations further can include generating, using a machine-learning model, a risk metric based at least on the usage patterns. The operations additionally can include outputting the risk metric.

Several embodiments can include one or more non-transitory computer-readable media storing computing instructions that, when executed by one or more processors, cause the one or more processors to perform certain operations. The operations can include obtaining one or more data sets collected based on a driver operating one or more vehicles having one or more autonomous driving systems. The operations also can include determining usage patterns for the one or more autonomous driving systems based at least on the one or more data sets. The operations further can include generating, using a machine-learning model, a risk metric based at least on the usage patterns. The operations additionally can include outputting the risk metric.

### ADDITIONAL CONSIDERATIONS

Although risk assessment based on usage of autonomous driving systems, it will be understood by those skilled in the art that various changes can be made without departing from the spirit or scope of the disclosure. Accordingly, the disclosure of embodiments is intended to be illustrative of the scope of the disclosure and is not intended to be limiting.

It is intended that the scope of the disclosure shall be limited only to the extent required by the appended claims. For example, to one of ordinary skill in the art, it will be readily apparent that any element of FIG. 1-4 can be modified, and that the foregoing discussion of certain of these embodiments does not necessarily represent a complete description of all possible embodiments. Additionally, one or more of the procedures, processes, operations, actions, and/or activities of the method in FIG. 4 can include different procedures, processes, actions, and/or activities and be performed by many different modules, in many different orders. As another example, the modules, models, elements, and/or systems within system 300 or risk assessment system 310 in FIG. 3 can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that can cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

As will be appreciated based upon the foregoing specification, the above-described embodiments of the disclosure can be implemented using computer programming or engineering techniques including computer software, firmware, hardware or any combination or subset thereof. Any such resulting program, having computer-readable code means, can be embodied, or provided within one or more computer-readable media, thereby making a computer program product, e.g., an article of manufacture, according to the discussed embodiments of the disclosure. The computer-readable media can be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code can be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor can include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In one embodiment, a computer program is provided, and the program is embodied on a computer readable medium. In an exemplary embodiment, the system can be executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various environments without compromising any major functionality. In some embodiments, the system includes multiple components distributed among a plurality of computing devices. One or more components can be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements, actions, operations, or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

For simplicity and clarity of illustration, the drawing figures illustrate the general manner of construction, and descriptions and details of well-known features and techniques can be omitted to avoid unnecessarily obscuring the present disclosure. Additionally, elements in the drawing figures are not necessarily drawn to scale. For example, the dimensions of some of the elements in the figures can be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but can include other elements not expressly listed or inherent to such process, method, system, article, device, or apparatus.

The terms “couple,” “coupled,” “couples,” “coupling,” and the like should be broadly understood and refer to connecting two or more elements mechanically and/or otherwise. Two or more electrical elements can be electrically coupled together, but not be mechanically or otherwise coupled together. Coupling can be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, “approximately” may, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

This written description uses examples to disclose the disclosure, including the best mode, and to enable any person skilled in the art to practice the disclosure, including making and using any devices or computer systems and performing any incorporated computer-based or computer-implemented methods. The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed:

1. A computer-implemented method comprising:
obtaining one or more data sets collected based on a driver operating one or more vehicles having one or more autonomous driving systems;
determining usage patterns for the one or more autonomous driving systems based at least on the one or more data sets;
generating, using a machine-learning model, a risk metric based at least on the usage patterns; and
outputting the risk metric.

2. The computer-implemented method of claim 1, wherein the one or more data sets comprise on-board connected card data of the one or more vehicles regarding usage of the one or more autonomous driving systems.

3. The computer-implemented method of claim 1, wherein the one or more data sets comprises telematics data collected by a mobile device of the driver while the driver is operating the one or more vehicles.

4. The computer-implemented method of claim 3, wherein determining the usage patterns comprises analyzing the telematics data to determine when the one or more autonomous driving systems are used based on differences in driving behavior between human-controller operation and operation of the one or more autonomous driving systems.

5. The computer-implemented method of claim 1, wherein determining the usage patterns comprises determining a proportion of time the one or more autonomous driving systems are used.

6. The computer-implemented method of claim 1, wherein determining the usage patterns comprises identifying patterns for disengagement events for the one or more autonomous driving systems.

7. The computer-implemented method of claim 1, wherein the risk metric is used in determining an insurance premium.

8. A system comprising one or more processors and one or more non-transitory computer-readable media storing computing instructions that, when executed on the one or more processors, cause the one or more processors to perform operations comprising:
obtaining one or more data sets collected based on a driver operating one or more vehicles having one or more autonomous driving systems;
determining usage patterns for the one or more autonomous driving systems based at least on the one or more data sets;
generating, using a machine-learning model, a risk metric based at least on the usage patterns; and
outputting the risk metric.

9. The system of claim 8, wherein the one or more data sets comprise on-board connected card data of the one or more vehicles regarding usage of the one or more autonomous driving systems.

10. The system of claim 8, wherein the one or more data sets comprises telematics data collected by a mobile device of the driver while the driver is operating the one or more vehicles.

11. The system of claim 10, wherein determining the usage patterns comprises analyzing the telematics data to determine when the one or more autonomous driving systems are used based on differences in driving behavior between human-controller operation and operation of the one or more autonomous driving systems.

12. The system of claim 8, wherein determining the usage patterns comprises determining a proportion of time the one or more autonomous driving systems are used.

13. The system of claim 8, wherein determining the usage patterns comprises identifying patterns for disengagement events for the one or more autonomous driving systems.

14. The system of claim 8, wherein the risk metric is used in determining an insurance premium.

15. One or more non-transitory computer-readable media storing computing instructions that, when executed by one or more processors, cause the one or more processors to perform operations comprising:
obtaining one or more data sets collected based on a driver operating one or more vehicles having one or more autonomous driving systems;
determining usage patterns for the one or more autonomous driving systems based at least on the one or more data sets;
generating, using a machine-learning model, a risk metric based at least on the usage patterns; and
outputting the risk metric.

16. The one or more non-transitory computer-readable media of claim 15, wherein the one or more data sets comprise on-board connected card data of the one or more vehicles regarding usage of the one or more autonomous driving systems.

17. The one or more non-transitory computer-readable media of claim 15, wherein the one or more data sets comprises telematics data collected by a mobile device of the driver while the driver is operating the one or more vehicles.

18. The one or more non-transitory computer-readable media of claim 17, wherein determining the usage patterns comprises analyzing the telematics data to determine when the one or more autonomous driving systems are used based on differences in driving behavior between human-controller operation and operation of the one or more autonomous driving systems.

19. The one or more non-transitory computer-readable media of claim 15, wherein determining the usage patterns comprises determining a proportion of time the one or more autonomous driving systems are used.

20. The one or more non-transitory computer-readable media of claim 15, wherein determining the usage patterns comprises identifying patterns for disengagement events for the one or more autonomous driving systems.
